(19) United States
(12) Patent Application Publication
(10) Pub. No.: US 2014/0345892 A1
(43) Pub. Date: Nov. 27, 2014

(54) EXCAVATING TOOL

(71) Applicant: ANTONIO E. CACELA, HOLDEN, MA (US)

(72) Inventor: ANTONIO E. CACELA, HOLDEN, MA (US)

(21) Appl. No.: 13/898,476

(22) Filed: May 21, 2013

(51) Int. Cl. A01B 1/12

(52) U.S. Cl. CPC A01B 1/12
USPC 172/378

(57) ABSTRACT

A hoe-like excavation tool having an elongated handle, and a hoe plate mounted to one end of the handle, perpendicular to the handle and offset from the axis of the handle. The plate has a sharp working edge, and a plurality of teeth extending outward from the edge.

### CROSS-REFERENCE TO RELATED APPLICATIONS

This application claims the benefit under 35 U.S.C. §119(e) of U.S. Provisional Application No. 61/649,340 filed May 20, 2012, the entire contents of which is hereby incorporated by reference.

### STATEMENT REGARDING FEDERALLY SPONSORED RESEARCH OR DEVELOPMENT

This invention has been created without the sponsorship or funding of any federally sponsored research or development program.

### FIELD OF THE INVENTION

This invention involves a hand tool for excavation.

### BACKGROUND OF THE INVENTION

I have been using tools most of my life, having grown up on a farm and using a variety of tools as a part of our daily routine.

More recently, I have established and run (hands-on involvement) a hardscaping construction company.

More than ten years ago, I purchased a couple of hoes at a regional hardware store (around $70 apiece) to supplement a couple of others which we used on just about all aspects of our work—excavating and site prep, as well as cleaning-up hard concrete cream from form boards. Although we use hydraulic equipment, there are instances in which machinery cannot be used, either due to physical limitations where access is not an option, or when the final excavation involves digging around utility lines and must be performed manually.

From actual first-hand field experience, these tools were not adequate for the job, especially here in the New England rocky soil. For instance, the blades are weak and bend backward out of form during moderate working load conditions and often had to be righted before proceeding again.

The eye ring, where the handle connects to the blade, is shallow, thereby providing inadequate grip of the blade unit. This condition creates a high stress point, resulting in the handle frequently loosening up due to wood fiber failure. Often, the handle broke there, usually at the most inopportune time.

With one particular hoe, over the last twelve years, perhaps because we used it more often, the thin steel blade (same as the others) cracked at least five or six times and one corner of the blade broke off completely. In all instances, I welded the blade back into working condition

We also use other tools from picks to mattocks to pry-bars, and rakes, etc. These are task specific, for work such as prying out and lifting larger rocks or cutting roots during site prep. However, they are not efficient for regular work flow and would be too heavy for sustained work, even in the hands of the strongest of laborers.

Prior systems for excavating hard-packed, stony, and root-filled soil, or hard packed snow, have proved to be inefficient, difficult to use, and prone to failure.

These and other difficulties experienced with the prior art devices have been obviated in a novel manner by the present invention.

It is, therefore, an outstanding object of some embodiments of the present invention to provide a hand tool for excavation, that overcomes the shortcomings of prior devices.

With these and other objects in view, as will be apparent to those skilled in the art, the invention resides in the combination of parts set forth in the specification and covered by the claims appended hereto, it being understood that changes in the precise embodiment of the invention herein disclosed may be made within the scope of what is claimed without departing from the spirit of the invention.

### BRIEF SUMMARY OF THE INVENTION

This invention is a hoe-like excavation tool having an elongated handle, and a hoe plate mounted to one end of the handle, perpendicular to the handle and extending outward from the axis of the handle. The plate has a castellated working edge, comprising a plurality of teeth extending outward from the edge, and cutting edges between the teeth. The tool also has cutter plate mounted to one end of the handle, perpendicular to the handle and extending outward from the axis of the handle, opposed to the hoe plate.

### BRIEF DESCRIPTION OF THE DRAWINGS

The character of the invention, however, may best be understood by reference to one of its structural forms, as illustrated by the accompanying drawings, in which:

FIG. 1 is a perspective view of an tool embodying the principles of the present invention, as it is employed by a user.

FIG. 2 is shows a plan view, looking down the handle, of a first embodiment including some of the principles of the present invention.

FIG. 3 shows a right side view of the lower portion of the first embodiment, shown in FIG. 2. The left side view is the mirror image of this view.

FIG. 4 shows a front view of the lower portion of the first embodiment, shown in FIG. 2.

FIG. 5 shows a back view of the lower portion of the first embodiment, shown in FIG. 2.

FIG. 6 shows a bottom view of the lower portion of the first embodiment, shown in FIG. 2.

FIG. 7 shows a full-length front view of the first embodiment, shown in FIG. 2.

FIG. 8 shows a full-length right side view of the first embodiment, shown in FIG. 2. The left side view is the mirror image of this view.

FIG. 9 shows a full-length back view of the first embodiment, shown in FIG. 2.

FIG. 10 shows a plan view, looking down the handle, of a second embodiment of the present invention.

FIG. 11 shows a right side view of the lower portion of the second embodiment, shown in FIG. 10. The left side view is the mirror image of this view.

FIG. 12 shows a front view of the lower portion of the second embodiment, shown in FIG. 10.

FIG. 13 shows a back view of the lower portion of the second embodiment, shown in FIG. 10.

FIG. 14 shows a bottom view of the second embodiment, shown in FIG. 10.

FIG. 15 shows a full-length front view of the second embodiment, shown in FIG. 10.

FIG. 16 shows a full-length right side view of the second embodiment, shown in FIG. 10. The left side view is the mirror image of this view.

FIG. 17 shows a full-length back view of the second embodiment, shown in FIG. 10.

FIG. 18 shows a perspective view of a small portion of the hoe plate, including two teeth and the blade edge between the two teeth and set back from the forward edge of the two teeth.

FIG. 19 shows a front elevation view of the hoe plate portion shown in FIG. 18, and showing the blade approaching a typical root found in soil.

FIG. 20 shows a front elevation view of the hoe plate portion having cut through the root.

FIG. 21 shows a right elevation view, in section taken along line 21-21 of FIG. 20, showing the root severed by the blade.

FIG. 22 shows the manner in which the adjacent teeth protect the blade from large stones which are the primary mechanism by which the blade is dulled.

FIG. 23 shows the manner in which the adjacent teeth allow small stones to approach the blade.

### DETAILED DESCRIPTION OF THE INVENTION

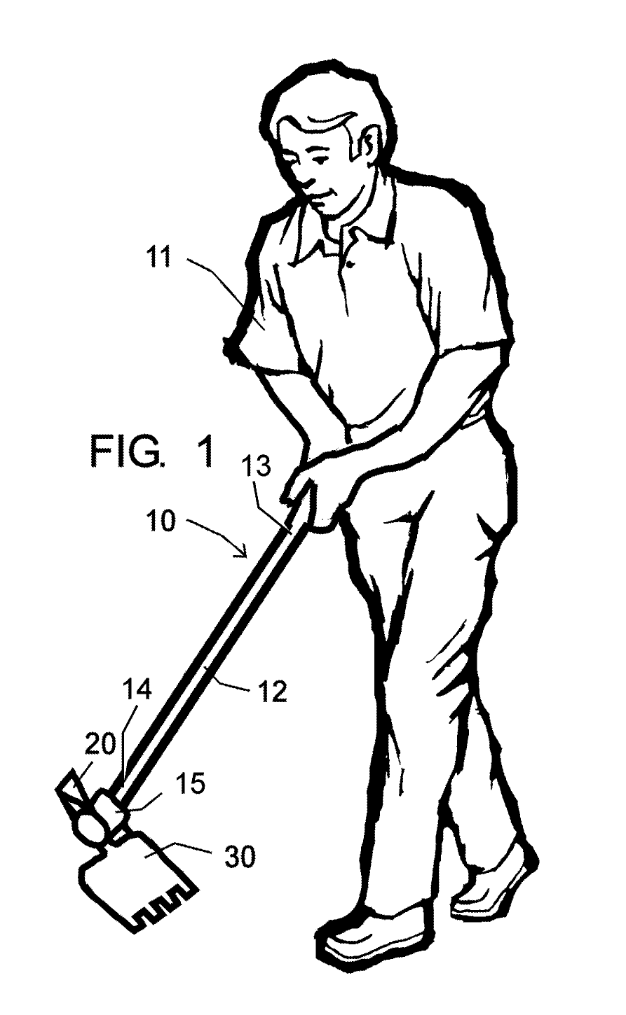

Referring first to FIG. 1 in which the general principles of the present invention are shown, FIG. 1 shows the manner in which the user 11 uses the hoe-like tool designated generally by the 10. The tool 10 includes an elongated handle 12 having a first end 13 which is held by the user 11, and a second end 14. A collar 15 is mounted on the second end 14 of the handle 12. Attached to one side of the collar 15 is a hoe plate 30, perpendicular to the handle and extending outward from the axis of the handle. The plate 30 has a castellated working edge 35, comprising a plurality of teeth 36 extending outward from the edge, and cutting edges or blades 37 between the teeth, and set back from the outer edge of the teeth 36. The tool 12 also has cutter plate 20 mounted to the collar 15, perpendicular to the handle, extending outward from the axis of the handle 12, and opposed to the hoe plate 30.

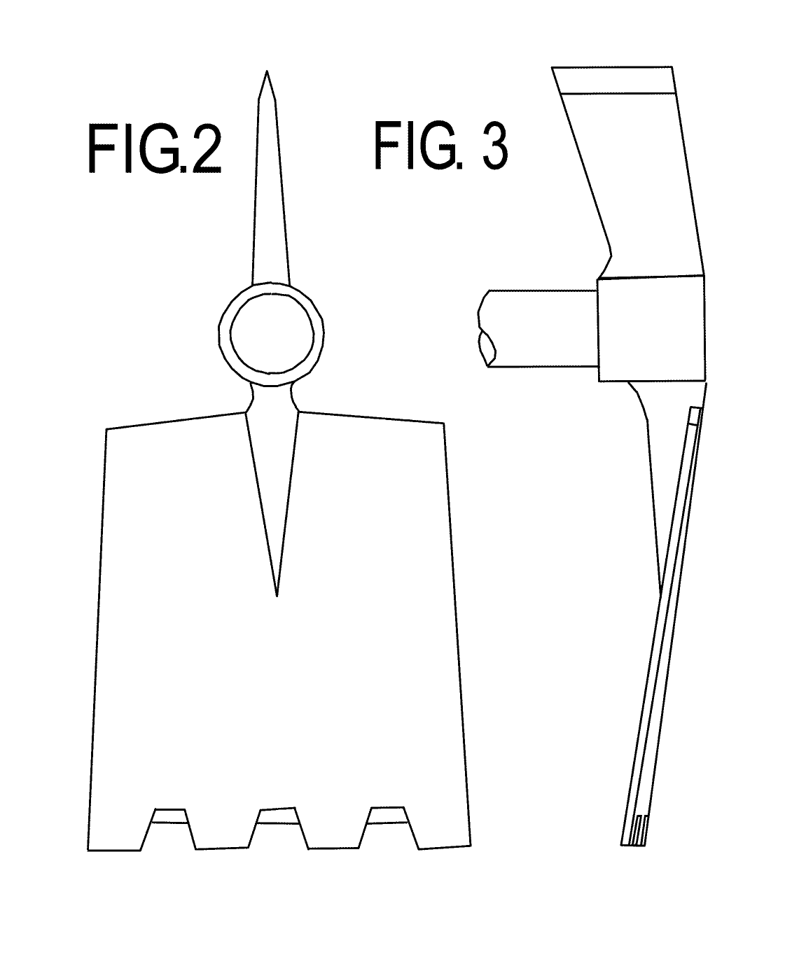

FIG. 2 is shows a plan view, looking down the handle, of a first embodiment including some of the principles of the present invention.

FIG. 3 shows a right side view of the lower portion of the first embodiment, shown in FIG. 2. The left side view is the mirror image of this view.

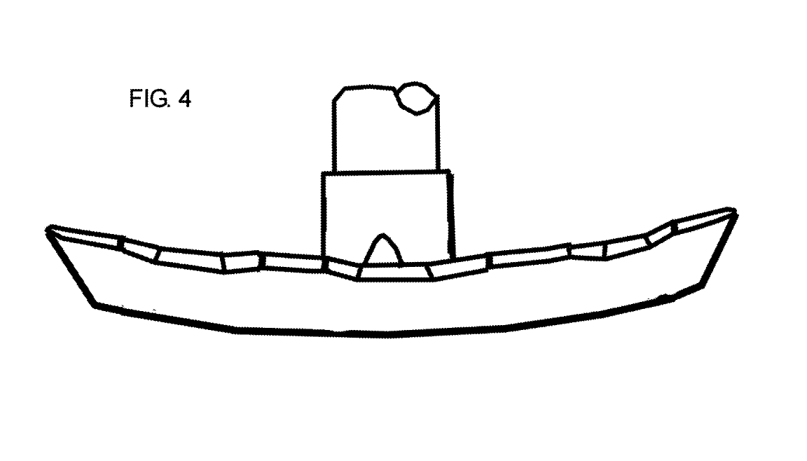

FIG. 4 shows a front view of the lower portion of the first embodiment, shown in FIG. 2.

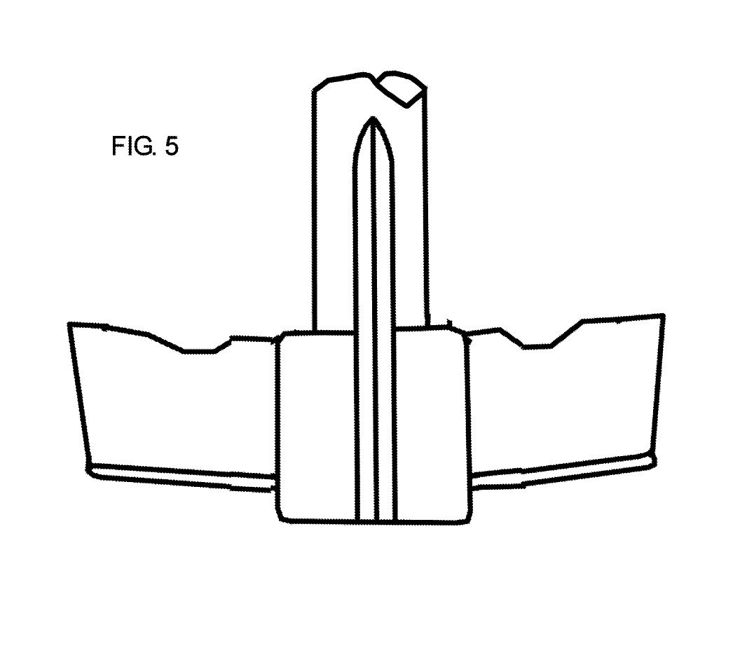

FIG. 5 shows a back view of the lower portion of the first embodiment, shown in FIG. 2.

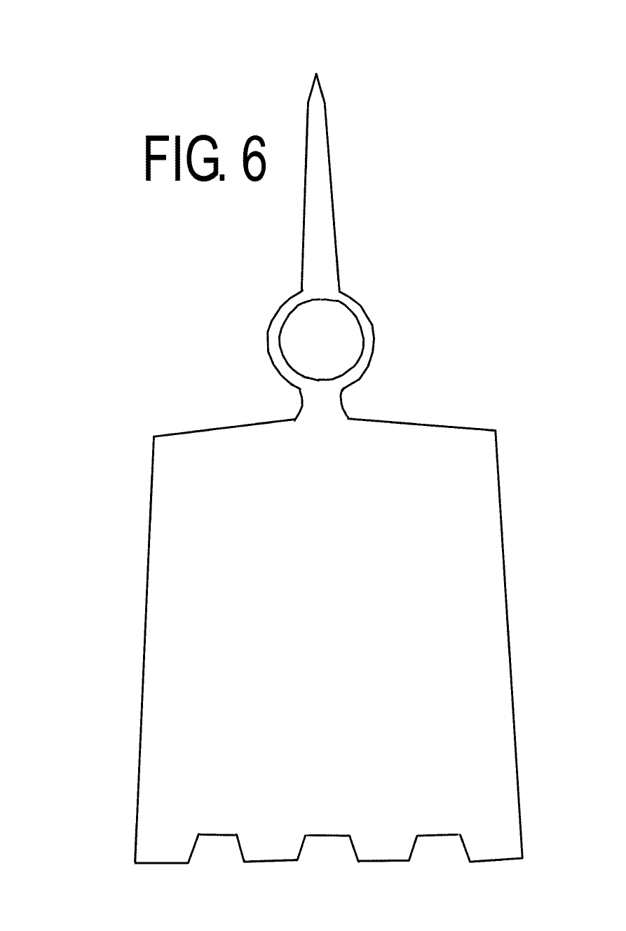

FIG. 6 shows a bottom view of the lower portion of the first embodiment, shown in FIG. 2.

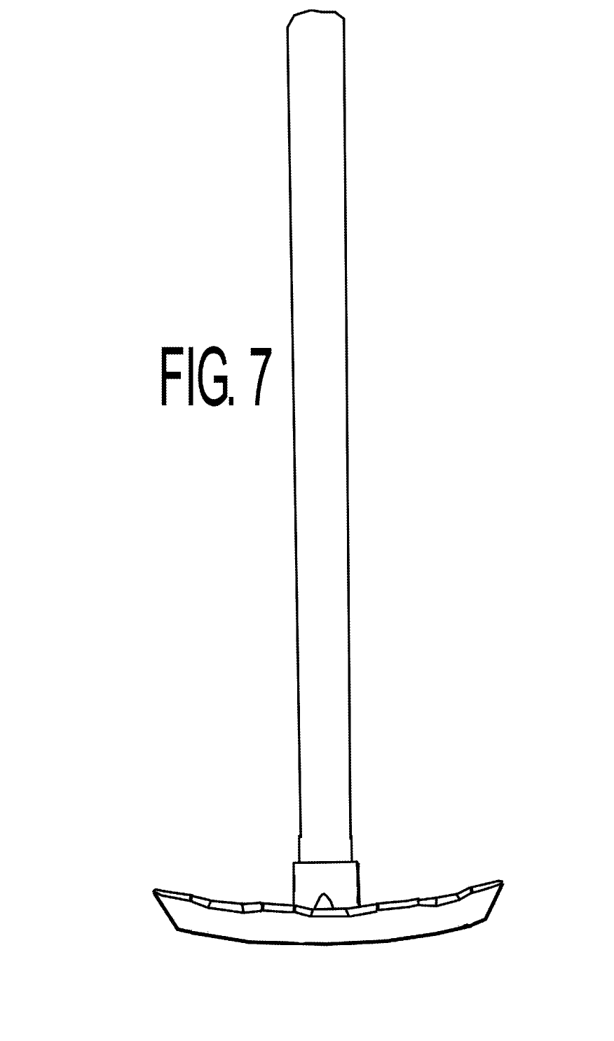

FIG. 7 shows a full-length front view of the first embodiment, shown in FIG. 2.

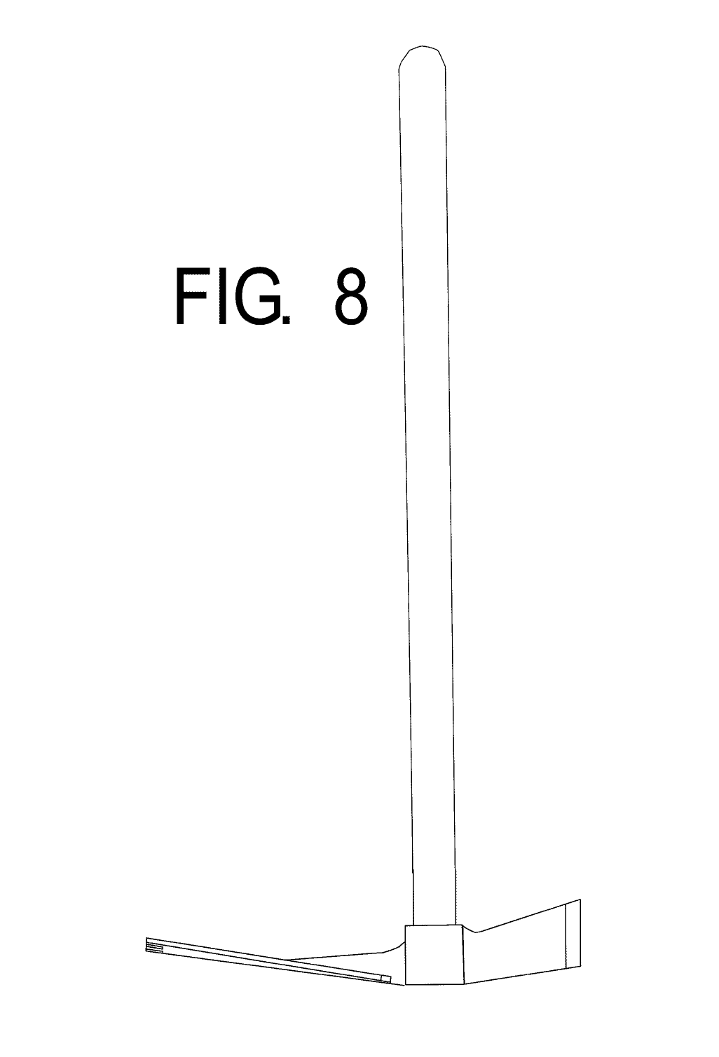

FIG. 8 shows a full-length right side view of the first embodiment, shown in FIG. 2. The left side view is the mirror image of this view.

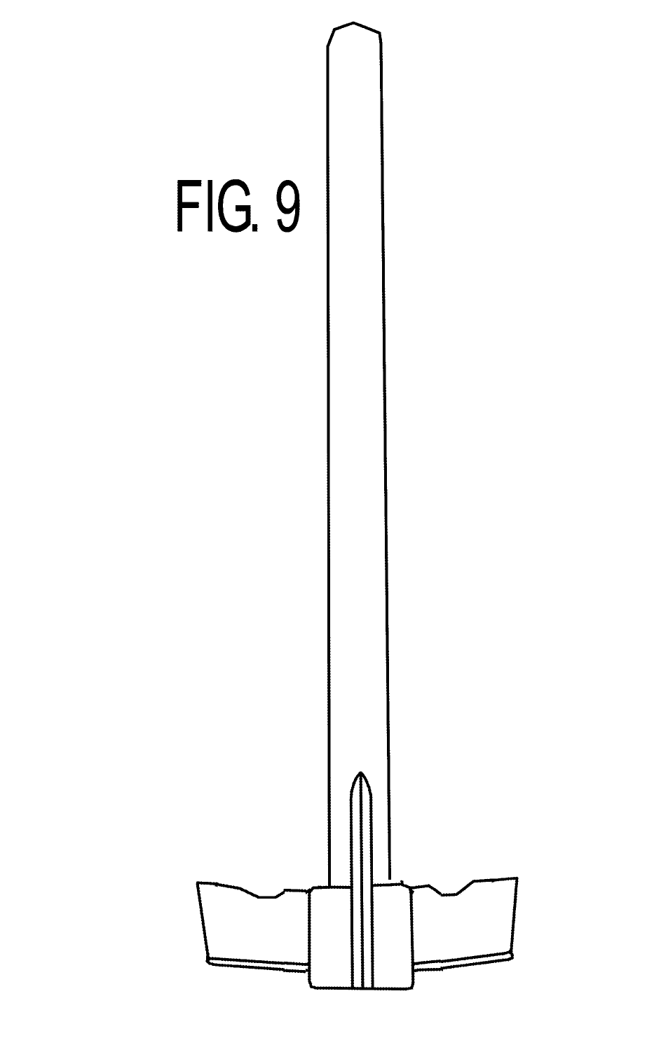

FIG. 9 shows a full-length back view of the first embodiment, shown in FIG. 2.

FIG. 10 shows a plan view, looking down the handle, of a second embodiment of the present invention.

FIG. 11 shows a right side view of the lower portion of the second embodiment, shown in FIG. 10. The left side view is the mirror image of this view.

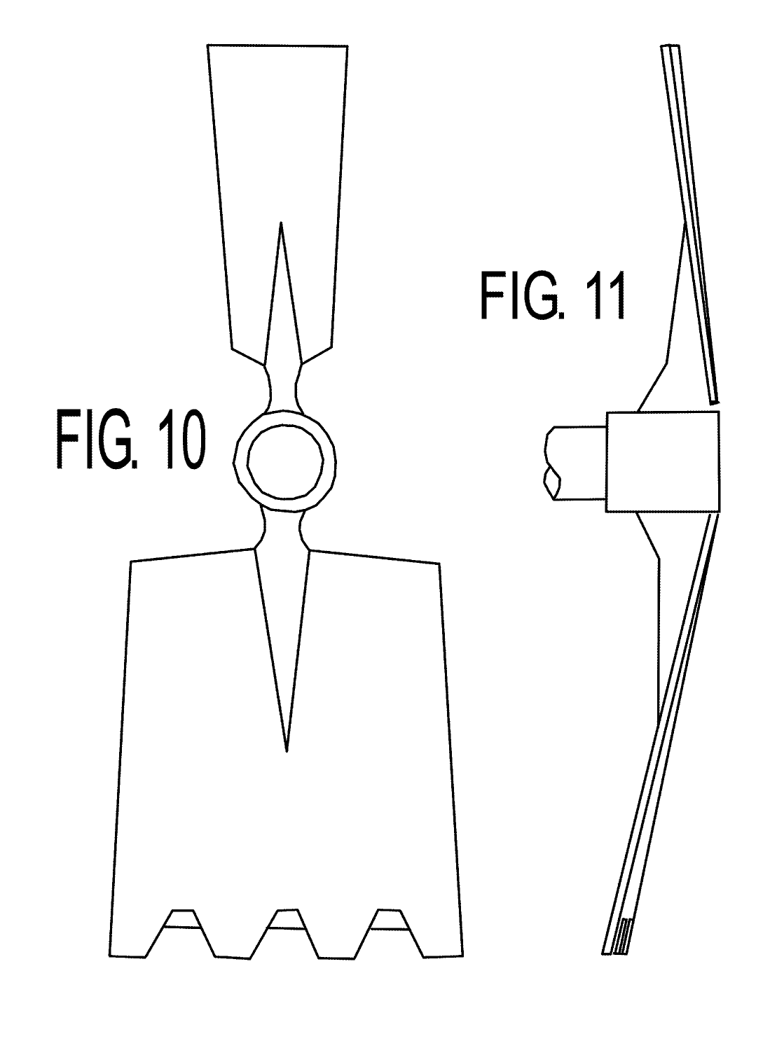

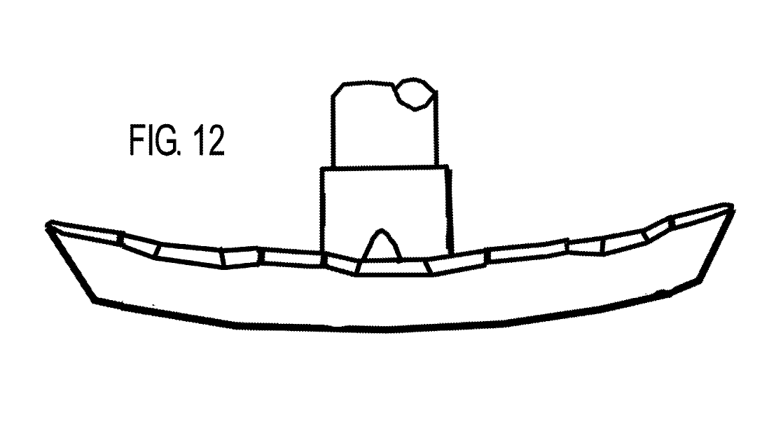

FIG. 12 shows a front view of the lower portion of the second embodiment, shown in FIG. 10.

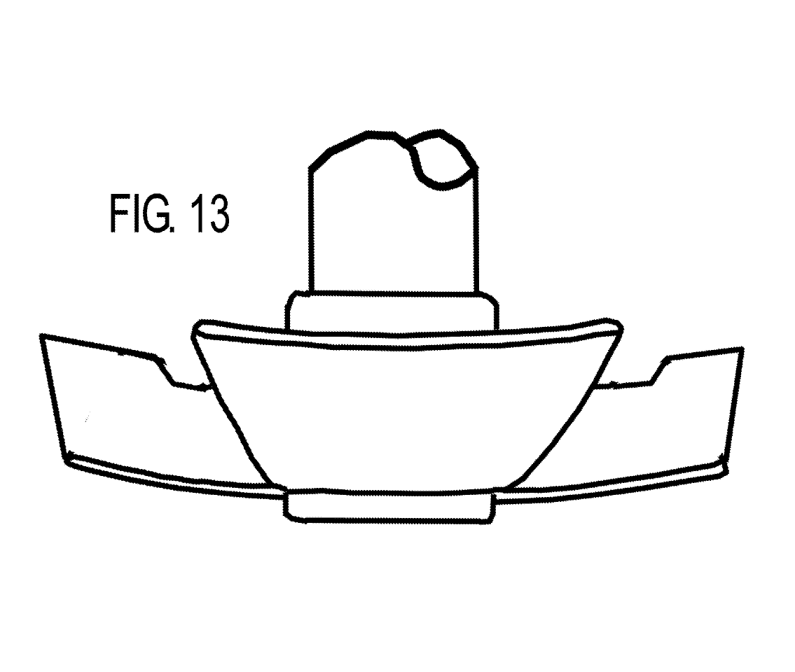

FIG. 13 shows a back view of the lower portion of the second embodiment, shown in FIG. 10.

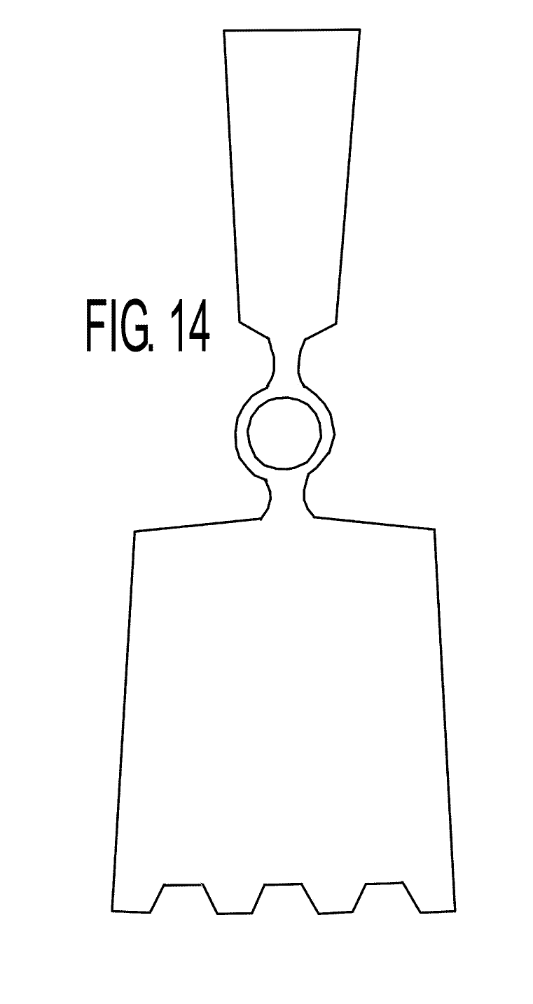

FIG. 14 shows a bottom view of the second embodiment, shown in FIG. 10.

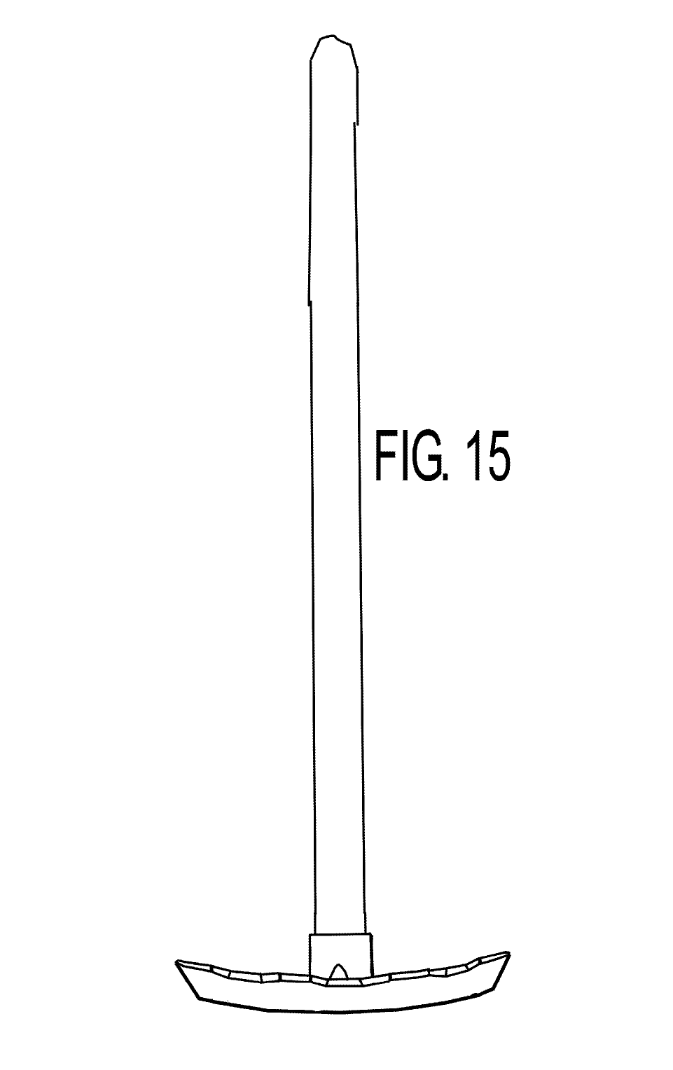

FIG. 15 shows a full-length front view of the second embodiment, shown in FIG. 10.

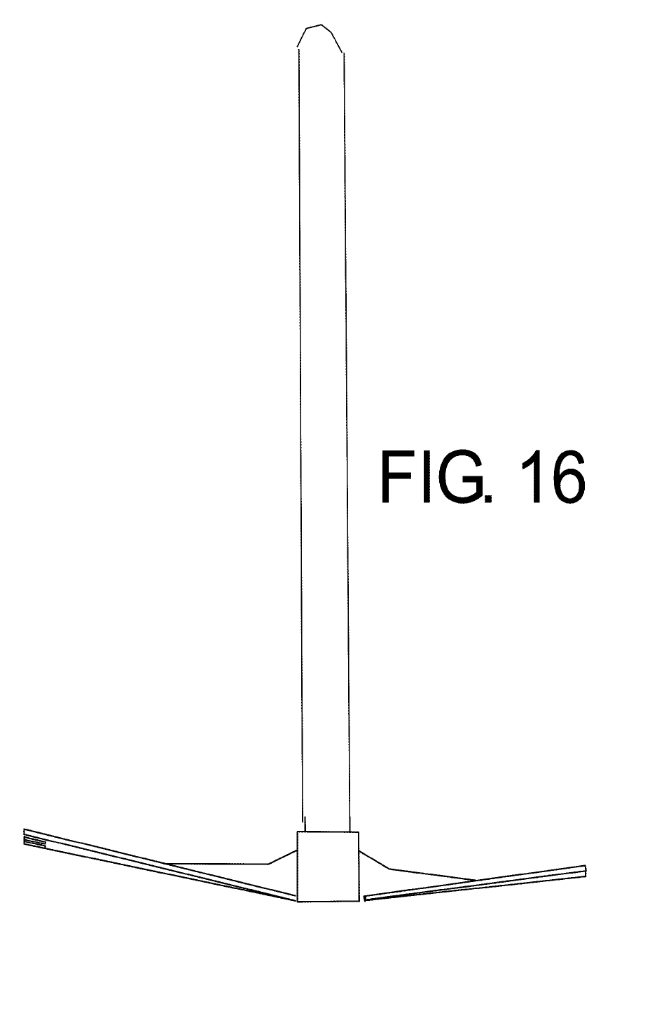

FIG. 16 shows a full-length right side view of the second embodiment, shown in FIG. 10. The left side view is the mirror image of this view.

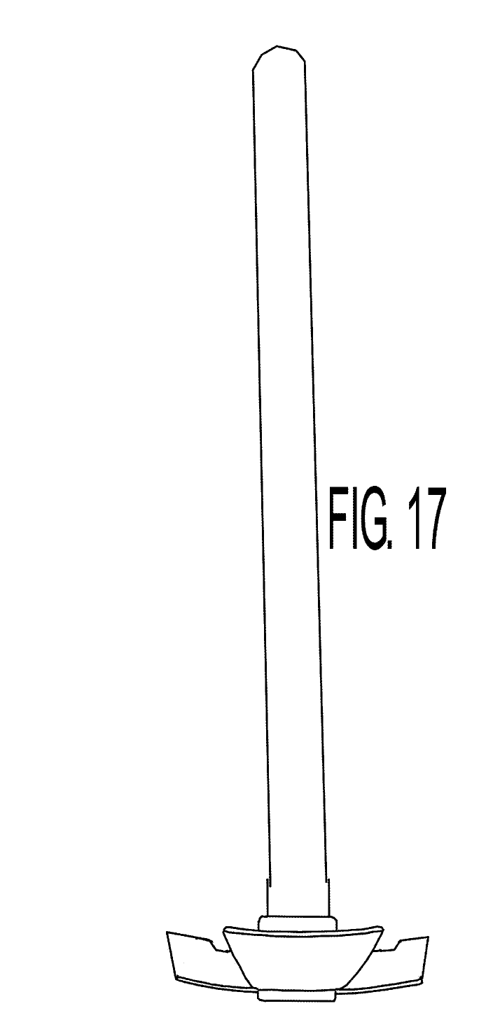

FIG. 17 shows a full-length back view of the second embodiment, shown in FIG. 10.

I have often felt, especially when my previous tools broke at the worst time, that I could design and build a tool far superior in every aspect for normal hand work and site conditions. A tool that would be very reliable, balanced in hand, strong but not too heavy, efficient and pleasing to the eye—where quality and good proportions would readily show. A tool that, even in the hands of a person with limited experience would yield sufficient results and feel good. A person of very little or no experience, such as some of my younger and older workers, would be able to learn how to use it efficiently in a very short time.

Over the last three or so years, I've dedicated a good deal of thought to the design of a site work tool that would stand on its own. A tool that under normal work conditions would last a lifetime and more. A tool that would have a high level of integrity in every detail. A tool that could be relied upon, time after time. A tool that could be used by a wide range of professional people, from small to large contractors, site workers, utility company workers, hardscapers, landscapers, forestry and agriculture workers . . . . Also, regular homeowners for the garden and smaller scale work around the yard would find this tool very useful.

I finally got everything lined up and, within last year, built several prototypes, tested, refined, tested again under site conditions, and am very pleased with excellent results:

Hoe—The hoe is built around a strong tool handling—eye, 2″ deep and 1⅞″ O.D. schedule 80 pipe ( 3/16″ thickness) as a hub for the blade at the front and either a hammer or axe on the backside. This eye has a good purchase or grab on the wooden handle which substantially reduces fiber stress and improves leverage. The eye or handle ring is flared toward the bottom (⅛″) so that the handle can be fitted properly and will not slip out during usage. Alternately, the wood handle can be substituted with structural fiberglass or composite material which is also non-electrically conductive.

The eye connector to the blade(s) is a solid, structurally strong member (as shown in the drawing) and extends into the blade by at least ⅓ of its length. The blade thickness is either 3/16″ or 10 gauge . . . . In both cases, the cutting edge has four teeth of the same thickness of the blade which are blunted, as shown, for the rigors of heavy duty work on rocky soils and sustained integrity. The actual sharper edge is set back from the leading edge teeth by ½″, the blade is also curved for extra strength (see drawing).

The axe, on the opposite end of the cutting edge is about 4″ in length (see drawing). This axe is 3/16″ thick and has two wings connected to the eye, for strength without extra weight.

During site prep work, roots are often in the way and must be removed. The great thing about the axe is its immediacy and convenience—by simply flipping this tool (hoe), this type of removal can be done without losing work momentum by constantly having to reach for another tool.

Alternately, in place of the axe, a hammer can be placed (built in) there for dressing up tough soil/clay or chipping off sharp edges on rock, as work progresses. All blades must be temper hardened (carburized) to the point where they are strong enough to maintain shape (flex and return to original shape) during stress work, yet not brittle, which increases the risk of breakage when a blow is struck on a hard surface, such as a large rock under the surface of the soil.

The blade, as sized, is perfect for all site work use. It can also dig a trench in one pass (very efficient) for laying pipe for drainage or utilities with minimal impact in residential projects, where often, access by a machine is limited or undesirable due to obstacles such as shrubs, planting beds, overhead clearance issues, fences, and other restrictions.

Landscapers can do many of their duties better using this tool (hoe) with much less effort and in a fraction of the time that it would take using other tools. I've personally planted many trees of different sizes, shrubs and flower beds over the years and this tool made the task much easier, much quicker and better. I would not even consider using any other tool alone for the purpose.

The lay of blades relative to the eye and therefore the handle (angle of departure from a straight line) is placed deliberately so that a wide range of people using the tool can work it without getting into awkward positions—it is comfortable to use.

GARDEN HOE—A scaled-down version of this tool is perfect for gardening (as shown in the blueprint). The blades are ⅛″ in thickness and the handle eye is 1½″ O.D. and 1¾″ deep. All the principles used in the construction of the full-sized model apply to this HOE also. On the opposite side of the main blade is a narrow blade which is perfect for weeding and quickly making a furrow for placing seed and placing small plants. The tool itself is very light so that almost anyone can handle it dexterously and feel a sense of accomplishment and surprising efficiency resulting in a good experience and the willingness to use it again.

Furthermore, many people, who work in other sedentary professions, look forward to and enjoy diversion in their daily routines by engaging in relatively small scale work around the yard, whether it be landscaping, hardscaping, or gardening, and derive benefit not only from their creativity with their own hands but also from the physical exercise—improving their physical and mental health.

One of the features that may be employed in connection with some of the embodiments of this invention might be called the “protected blade”. The most common use of this excavation tool would be to chop through hard-packed soil that includes both roots and stones of various sizes. Because the roots can be quite stringy and tough, it would be desirable to have a blade on the working edge of the hoe plate. This would allow the hoe to cut through the roots. The problem is that, when that concept is actually tried, the presence of stones in the soil quickly causes the blade to become dull and to lose its ability to cut through the roots.

This “protected blade” concept employs castellated teeth 36 at the working edge of the hoe plate 30. The back-set base edge between each tooth is sharpened into a cutting blade 37. The space between the teeth is flared outward between the blade 37 and the outer ends of the teeth 36, and about 30 degrees of the center line between the teeth, and thereby funnel roots between the teeth 36 and onto the blade 37.

FIG. 18 shows a perspective view of a small portion of the hoe plate 30, including two teeth 36 and the blade edge between the two teeth and set back from the forward edge of the two teeth.

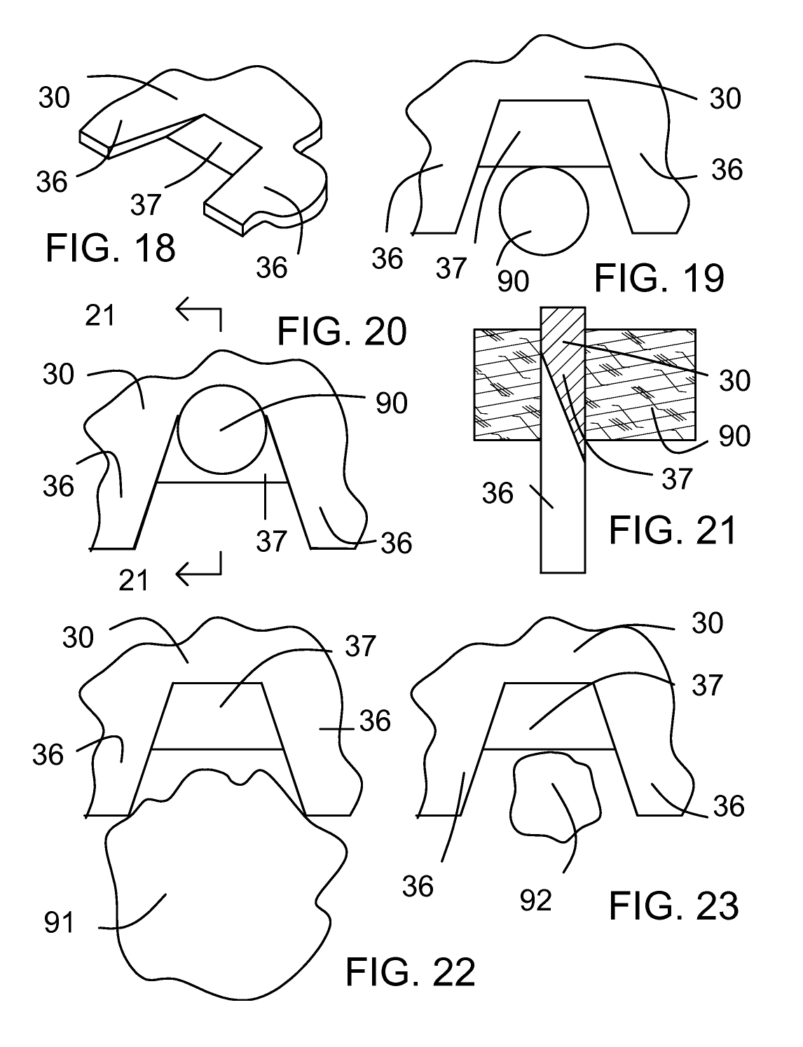

FIG. 19 shows a front elevation view of the hoe plate 30 portion shown in FIG. 18, and showing the blade 37 approaching a typical root 90 found in soil. The root 90 has passed freely between the two adjacent teeth 36, toward the blade 37.

FIG. 20 shows a front elevation view of the hoe plate 30 portion having cut through the root 90.

FIG. 21 shows a right elevation view, in section taken along line 21-21 of FIG. 20, showing the root 90 severed by the blade 37.

FIG. 22 shows the manner in which the adjacent teeth 36 protect the /blade 37 from large stones 91 which are the primary mechanism by which the blade 37 is dulled.

FIG. 23 shows the manner in which the adjacent teeth 36 allow small stones 92 to approach the blade 37. It has been found that small stones 92 have minimal dulling effect on the blade 37. This appears to be because the small stones 92 have significantly smaller mass and inertia, and because they have a significantly reduced cross-section, so that the small stones tend to be pushed out of the way by the blade 37 rather than resisting the blades force and thereby dulling the blade edge.

It is obvious that minor changes may be made in the form and construction of the invention without departing from the material spirit thereof. It is not, however, desired to confine the invention to the exact form herein shown and described, but it is desired to include all such as properly come within the scope claimed.

The invention having been thus described, what is claimed as new and desire to secure by Letters Patent is:

1. A hoe-like excavation tool, comprising:
a. an elongated handle,
b. a hoe plate mounted to one end of the handle, perpendicular to the handle and offset from the axis of the handle, and
wherein the plate has a sharp working edge, and a plurality of teeth extending outward from the edge.
